(19) United States
(12) Patent Application Publication
(10) Pub. No.: US 2024/0030505 A1
(43) Pub. Date: Jan. 25, 2024

(54) ACTIVATION APPARATUS FOR SECONDARY BATTERY AND ACTIVATION METHOD THEREFOR

(71) Applicant: LG ENERGY SOLUTION, LTD., Seoul (KR)

(72) Inventors: Ji Soo PARK, Daejeon (KR); Yong Nam KIM, Daejeon (KR); So Yeon NOH, Daejeon (KR); Young Hyun LEE, Daejeon (KR)

(73) Assignee: LG ENERGY SOLUTION, LTD., Seoul (KR)

(21) Appl. No.: 18/266,171

(22) PCT Filed: Oct. 7, 2022
(86) PCT No.: PCT/KR2022/015161

§ 371 Date: Jun. 8, 2023

(30) Foreign Application Priority Data
Oct. 8, 2021 (KR) 10-2021-0134412

(51) Int. Cl. H01M 10/44; H01M 10/04; H01M 10/52

(52) U.S. Cl. CPC H01M 10/446; H01M 10/0404; H01M 10/52

(57) ABSTRACT

An activation apparatus for a secondary battery includes a first chamber having a first conveyor for conveying a battery cell and being capable of adjusting a vacuum level in a space in which the first conveyor is located; a vacuum chamber having an activation unit in which the battery cell is disposed so that activation and degassing of the battery cell are performed, the vacuum chamber being capable of maintaining a vacuum state in a space in which the activation unit is located; a second chamber having a second conveyor for conveying the battery cell and being capable of adjusting a vacuum level in a space in which the second conveyor is located; a movement line crossing the first chamber, the vacuum chamber, and the second chamber; and a carrier connected to the movement line to move the battery cell along the movement line.

### TECHNICAL FIELD

### Cross-Reference to Related Application

The present application claims the benefit of the priority of Korean Patent Application No. 10-2021-0134412, filed on Oct. 8, 2021, which is hereby incorporated by reference in its entirety.

### TECHNICAL FIELD

The present invention relates to an activation apparatus for activating a battery cell of a pouch-type secondary battery during an activation process of the secondary battery, and an activation method therefor.

### BACKGROUND ART

The amount of usable fossil fuels is limited as fossil fuels are gradually depleted, and the importance of preventing environmental pollution is also increasing. Therefore, the importance of energy capable of replacing the fossil fuels is increasing. Accordingly, research and development of power production technologies are being actively conducted based on energy sources that have little impact on environmental pollution, such as solar heat, water power, wind power, marine energy, and biomass energy.

In particular, research on repeatedly chargeable secondary battery capable of preventing environmental pollution and providing high energy density has been most actively conducted. Physical, electrical, mechanical, and systematic research and development on materials, efficiency, structures, and processes of the secondary batteries are being conducted in various aspects.

These secondary batteries are mainly classified into cylindrical batteries, prismatic batteries, and pouch-type batteries according to shapes thereof. Therefore, research and development are being conducted to improve energy efficiency and energy density or prevent energy inefficiency according to structural characteristics corresponding to each type of secondary batteries having various shapes.

The secondary batteries have advantages over other types of energy sources in terms of energy efficiency and density, but studies on stability are being conducted to secure higher efficiency along with continuous development of structures, materials, and processes. In particular, various processes are performed in a manufacturing process of the secondary batteries, and thus, precise control of movement, structure, arrangement, and assembly of battery cells is required for each process. Therefore, the stability is of great importance.

### DISCLOSURE OF THE INVENTION

### Technical Problem

A pouch-type battery has a shape in which an electrode assembly is accommodated in a pouch-type case, and high energy density may be secured in this type of battery by accommodating, in the case, the electrode assembly in which electrodes and separators are alternately stacked. However, for high stability along with high efficiency, it is essential to discharge gas generated in the pouch-type case during charging and discharging in a battery cell activation process. Also, a high degree of precision/air-tightness in a manufacturing process of a secondary battery is required for gas discharge.

However, the gas collected in the pouch-type case may not be properly removed during the manufacturing process of the secondary battery, and thus, the energy efficiency or safety of the secondary battery due to an increase in internal pressure may be deteriorated during use of the secondary battery.

An object of the present invention for solving the above limitations is to provide an activation apparatus for a secondary battery and an activation method therefor, capable of discharging gases, which may be generated during the manufacturing process of the secondary battery, as much as possible during charging/discharging of the activation process, and also capable of producing a secondary battery that can be stably manufactured/used.

### Technical Solution

An activation apparatus for a secondary battery according to the present invention includes: a first chamber having a first conveyor configured to convey a battery cell, the first chamber being configured to adjust a vacuum level in a space in which the first conveyor is located; a vacuum chamber spatially connected to the first chamber, the vacuum chamber including an activation unit configured to receive the battery cell so that activation and degassing of the battery cell are performed, the vacuum chamber being configured to maintain a vacuum state in a space in which the activation unit is located; a second chamber spatially connected to the vacuum chamber, the second chamber having a second conveyor unit configured to convey the battery cell, the second chamber being configured to adjust a vacuum level in a space in which the second conveyor is located; a movement line crossing the first chamber, the vacuum chamber, and the second chamber; and a carrier connected to the movement line, the carrier being configured to move the battery cell along the movement line, wherein piercing of the battery cell is performed in the first chamber, wherein the activation and degassing of the battery cell are performed in the activation unit, and wherein sealing of the battery cell is performed in the vacuum chamber or the second chamber.

The carrier may include a first member and a second member, wherein the first member includes a heating pad on a first surface and a piercing pin on a second surface opposite the first surface, wherein the second movement member includes a vacuum pad on a first surface, and wherein the first member is rotatable between a state in which the piercing pin faces the vacuum pad and a state in which the heating pad faces the vacuum pad.

The piercing may be performed by the piercing pin of the first member and the vacuum pad of the second member, and the sealing may be performed by the heating pad of the first member and the vacuum pad of the second member.

The activation unit may include a pressing jig, and the pressing jig may be configured to press the battery cell during the activation, thereby performing the degassing.

The first chamber may have a first gate, and the first gate may be opened when the vacuum level of the first chamber is adjusted to the vacuum state of the vacuum chamber.

The second chamber may have a second gate, and the second gate may be opened when the vacuum level of the second chamber is adjusted to the vacuum state of the vacuum chamber.

In the sealing of the battery cell by the carrier, a first sealing may be performed while the carrier is brought into contact with the battery cell to move the battery cell, and a second sealing may be performed while the carrier places the battery cell in the second chamber.

The first chamber may include a first activation tray, and the battery cell conveyed from the first conveyor may be disposed on the first activation tray. The second chamber may include a second activation tray, and the battery cell moved from the vacuum chamber may be disposed on the second activation tray.

The battery cell may include a sealing portion and a degassing portion in the sealing portion, wherein a gas inside the battery cell is discharged via the degassing portion by pressing at least a portion of the sealing portion.

The activation of the battery cell may be performed in the activation unit in a state in which the piercing has been performed.

An activation method for a secondary battery according to the present invention may include: conveying a battery cell to a first chamber by a first conveyor, adjusting a vacuum level in a space in which the first conveyor is located in the first chamber; piercing the battery cell in the first chamber by a carrier; moving the battery cell to a vacuum chamber along a movement line by the carrier, wherein the vacuum chamber is in a vacuum state, activating and degassing the battery cell by an activation unit located in the vacuum chamber; sealing the battery cell by the carrier; moving the battery cell to a second chamber along the movement line by the carrier, and adjusting a vacuum level in the second chamber.

The activation method for a secondary battery may include pressing the battery cell during the activating the battery cell, thereby degassing the battery cell.

The activation method for a secondary battery may include opening a first gate of the first chamber when the vacuum level of the first chamber is adjusted to the vacuum state of the vacuum chamber.

The activation method for a secondary battery may include opening a second gate of the second chamber when the vacuum level of the second chamber is adjusted to the vacuum state of the vacuum chamber.

The activation method for a secondary battery may include activating the battery cell in the activation unit after the piercing of the battery cell.

### Advantageous Effects

An activation apparatus for a secondary battery and an activation method therefor according to the present invention may provide high stability as gases, which may be generated/collected in a pouch during charging/discharging, are efficiently removed in an activation process of a battery cell of the secondary battery.

The activation apparatus for a secondary battery and the activation method therefor according to the present invention may simplify processes and reduce the size of the battery cell as the gases are discharged using a vacuum chamber in the activation process without adding a separate gas removal process.

### BRIEF DESCRIPTION OF THE DRAWINGS

FIG. 1 is a view showing a battery cell of a pouch-type secondary battery according to an embodiment of the present invention.

FIG. 2 is a view showing a movement member according to an embodiment of the present invention.

FIGS. 3A to 3D are views showing states of the movement member according to an embodiment of the present invention and states of the battery cell corresponding thereto.

FIG. 4 is a view showing a gas removing method for a battery cell of a secondary battery according to another embodiment of the present invention.

FIG. 5 is a view showing an activation apparatus for removing a gas from a battery cell of a secondary battery according to another embodiment of the present invention.

### MODE FOR CARRYING OUT THE INVENTION

Hereinafter, embodiments of the present invention will be described in detail with reference to the accompanying drawings so as to be easily carried out by a person skilled in the art to which the present invention pertains. However, the present invention may be embodied in various different forms, and is neither limited nor restricted to the following embodiments.

In order to clearly describe the present invention, detailed description of parts irrelevant to the invention or detailed descriptions of related well-known technologies that may unnecessarily obscure subject matters of the invention will be omitted. In the specification, when reference numerals are given to components in each of the drawings, the same or similar components will be designated by the same or similar reference numerals throughout the specification.

Also, terms or words used in this specification and claims should not be restrictively interpreted as ordinary meanings or dictionary-based meanings, but should be interpreted as meanings and concepts conforming to the technical ideas of the present invention on the basis of the principle that an inventor can properly define the concept of a term so as to describe his or her invention in the best ways.

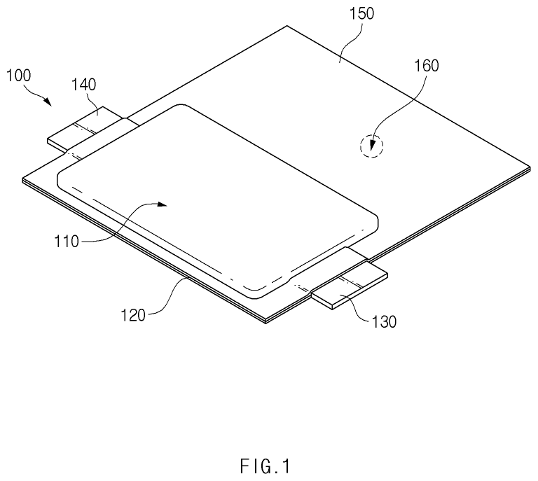

FIG. 1 shows a battery cell of a pouch-type secondary battery according to an embodiment of the present invention.

A battery cell 100 may include an electrode assembly 110, and the electrode assembly 110 may be accommodated in an accommodation part inside a pouch 120. The accommodation part may have a shape corresponding to a shape of the electrode assembly 110.

The battery cell 100 may include electrode leads 130 and 140 that electrically connect the electrode assembly 110 to the outside of the battery cell 100. The electrode leads 130 and 140 are connected to a portion of the electrode assembly 110 and may cross the pouch 120 and be exposed to the outside.

The pouch 120 may include a sealing portion 150 which may seal at least a region around the electrode assembly 110 and collect gas that may be generated during a manufacturing process of the battery cell 100. The sealing portion 150 may seal the battery cell 100 as exterior materials of the pouch 120 are bonded to each other.

A degassing portion 160 may be included in the sealing portion 150. The degassing portion 160 may be a portion through which the gas collected in the sealing portion 150 is discharged.

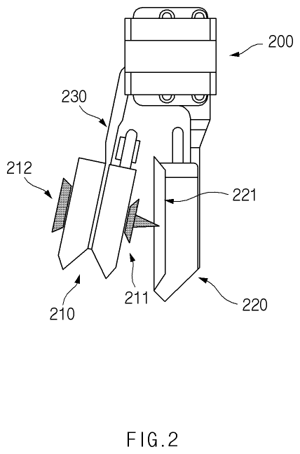

FIG. 2 shows a movement member according to an embodiment of the present invention.

In the activation apparatus for a secondary battery and the activation method therefor according to the present invention, a movement member 200 may serve as a means for moving the battery cell 100.

The movement member 200 may include a first movement member 210 and a second movement member 220 to pick and move the battery cell 100. One side of the first movement member 210 and one side of the second movement member 220 may be brought into contact with both surfaces of the battery cell 100 to pick up the battery cell 100. The battery cell 100 may be picked up and moved along a movement line by the first movement member 210 and the second movement member 220.

The movement member 200 may perform piercing and sealing of the battery cell 100.

As described above, the movement member 200 may include the first movement member 210 and the second movement member 220.

The first movement member 210 may include a piercing pin 211 and a heating pad 212.

The piercing pin 211 may be formed in a direction protruding outward from the first movement member 210. The piercing pin 211 may be formed on one side of the first movement member 210. The piercing pin 211 may perform piercing of the sealing portion 150 or the degassing portion 160 of the battery cell 100.

The heating pad 212 may be formed on the other side of the first movement member 210 opposite to the side on which the piercing pin 211 is disposed. The heating pad 212 may deliver heat and pressure to perform sealing of the sealing portion 150 or the degassing portion 160 of the battery cell 100.

The second movement member 220 may include a vacuum pad 221. The second movement member 220 may include the vacuum pad 221 on one side surface. The vacuum pad 221 may perform piercing of the battery cell 100 together with the piercing pin 211. The vacuum pad 221 may perform sealing of the battery cell 100 together with the heating pad 212.

The movement member 200 may include a rotary member 230. The rotary member 230 may be connected/coupled to the first movement member 210. The rotary member 230 may rotate the first movement member 210. The rotary member 230 may rotate the first movement member 210 by 360 degrees.

The rotary member 230 may rotate the first movement member 210 such that the piercing pin 211 faces (or is opposite to) the vacuum pad 221. The rotary member 230 may rotate the first movement member 210 such that the heating pad 212 faces (or is opposite to) the vacuum pad 221.

The movement member 200 may perform piercing and sealing of the battery cell 100 while moving same.

The movement member 200 may move along the movement line while picking up the battery cell 100 in a state in which the piercing pin 211 of the first movement member 210 faces the vacuum pad 221 of the second movement member 220, and thus may simultaneously perform moving and piercing of the battery cell 100.

The movement member 200 may move along the movement line while picking up the battery cell 100 in a state in which the heating pad 212 of the first movement member 210 faces the vacuum pad 221 of the second movement member 220, and thus may simultaneously perform moving and sealing of the battery cell 100.

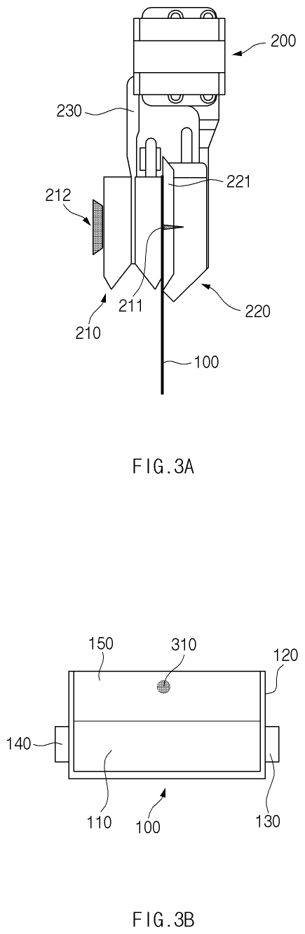

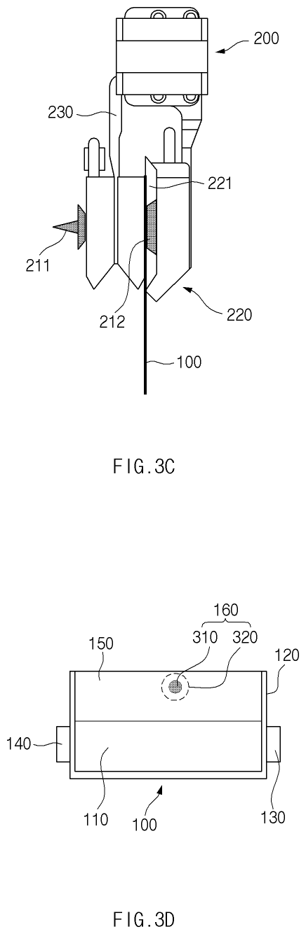

FIGS. 3A to 3D show states of the movement member according to an embodiment of the present invention and states of the battery cell corresponding thereto.

FIGS. 3A and 3B show states in which the movement member 200 may perform piercing and moving.

Referring to FIG. 3A, the piercing pin 211 of the first movement member 210 and the vacuum pad 221 of the second movement member 220 may be coupled while facing each other. The piercing pin 211 and the vacuum pad 221 may fix the battery cell 100 and simultaneously perform piercing of the degassing portion 160 of the battery cell 100.

Referring to FIG. 3B, a piercing hole 310 may be formed in the battery cell 100. The piercing hole 310 may be formed as the piercing pin 211 passes through a region corresponding to the degassing portion 160. The gas collected in the sealing portion 150 or the degassing portion 160 of the battery cell 100 may be discharged to the outside via the piercing hole 310 formed by the piercing pin 211. The vacuum pad 221 may suction the discharged gas.

FIGS. 3C and 3D show states in which the movement member 200 may perform sealing and moving.

Referring to FIG. 3C, the heating pad 212 of the first movement member 210 and the vacuum pad 221 of the second movement member 220 may be coupled while facing each other. The heating pad 212 and the vacuum pad 211 may perform sealing of the degassing portion 160 of the battery cell 100 while coming into contact with (or fixing) the battery cell 100.

Referring to FIG. 3D, a sealing region 320 may be formed in the battery cell 100. The sealing region 320 may be formed as a region corresponding to the degassing portion 160 is sealed by the heating pad 212 and the vacuum pad 221. After the gas is discharged via the sealing portion 150 or the degassing portion 160 of the battery cell 100, a region of the degassing portion 160 may be sealed by the heating pad 212 and the vacuum pad 221. Accordingly, the sealing region 320 may be formed. The sealing region 320 may be formed as the region of the degassing portion 160 is sealed by heat and pressure from the heating pad 212 and the vacuum pad 221.

The states of FIGS. 3A and 3B and the states of FIGS. 3C and 3D may be formed according to the rotation of the rotary member 230, and the first movement member 210 may be rotated in a range of 360 degrees by the rotary member 230.

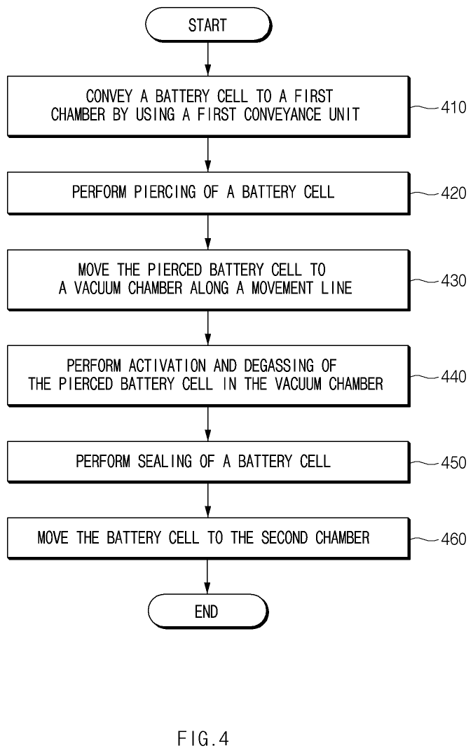

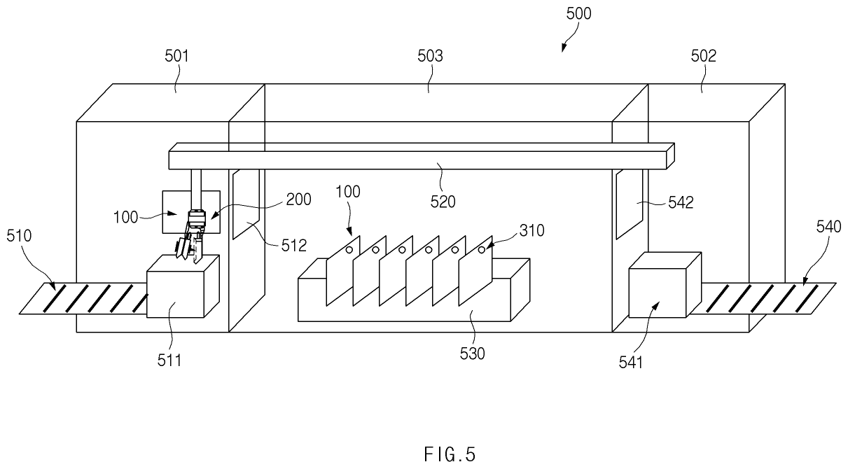

FIG. 4 shows a gas removing method for a battery cell of a pouch-type secondary battery according to another embodiment of the present invention. The activation apparatus for a secondary battery according to the present invention may perform a gas removing method for a battery cell as will be described later.

In the activation method of FIG. 4 by the activation apparatus according to the present invention, the activation apparatus performing gas removal for a battery cell of a secondary battery will be described with reference to FIG. 5.

In operation 410, the activation apparatus may convey a battery cell to a first chamber by using a first conveyance unit.

An activation apparatus 500 may include a first chamber 501, a second chamber 502, and a vacuum chamber 503.

The first chamber 501 may adjust a vacuum level inside the first chamber 501. The vacuum level inside the first chamber 501 may be adjusted from an atmospheric state to a vacuum state (e.g., −40 kpa). In the vacuum state, the vacuum level may be defined according to the design. In the present invention, −40 kpa is defined as the vacuum state, but the embodiment is not particularly limited.

A battery cell 100 may be conveyed from the outside of the activation apparatus 500 to the first chamber 501 by a first conveyance unit 510 of the first chamber 501. The battery cell 100 outside the activation apparatus 500 may be placed on a first activation tray 511 inside the first chamber 501 by the first conveyance unit 510. A plurality of battery cells 100 to be activated may be disposed on the first activation tray 511.

The vacuum level inside the first chamber 501 may be adjusted from the outside before, while, and after the battery cell 100 is conveyed.

In operation 420, the activation apparatus may perform piercing of a battery cell by using a movement member.

In the activation apparatus 500, a movement member 200 may be used to pick up the battery cell 100 disposed on the first activation tray 511. In this case, the movement member 200 may be in a state in which a piercing pin 211 of a first movement member 210 and a vacuum pad 221 of a second movement member 220 face each other.

In a state in which the piercing pin 211 of the first movement member 210 and the vacuum pad 221 of the second movement member 220 face each other, piercing may be performed as the piercing pin 211 passes through a degassing portion 160 of the battery cell 100.

The piercing of a portion of the battery cell 100 may be performed simultaneously with the movement member 200 gripping the battery cell 100.

In operation 430, the activation apparatus may move the pierced battery cell to a vacuum chamber along a movement line.

A movement line 520 may be disposed in the form that spatially crosses the first chamber 501, the second chamber 502, and the vacuum chamber 503. The movement line 520 may support the movement member 200 from the top so that the movement line can move.

The movement member 200 may be coupled to the movement line 520. The movement member 200 may be coupled to the movement member and move along the movement line 520.

The movement member 200 may move, along the movement line 520, to the vacuum chamber 503 via a first gate 512 formed between the first chamber 501 and the vacuum chamber 503.

When the movement member 200 moves into the vacuum chamber 503 via the first gate 512, the vacuum level inside the first chamber 501 may be adjusted to a vacuum state (e.g., −40 kpa). Also, when the vacuum level of the first chamber 501 becomes a vacuum state (e.g., −40 kpa), the first gate 512 may be opened.

In operation 440, the activation apparatus may perform activation and degassing of the pierced battery cell in the vacuum chamber.

In the activation apparatus 500, the battery cell 100 may be moved to the vacuum chamber 503 by using the movement member 200, and the battery cell 100 may be placed on an activation unit 530 by using the movement member 200.

The battery cell 100 placed on the activation unit 530 may be in a pierced state.

The activation unit 530 may include a pressing jig, and the battery cell 100 may be pressed by the pressing jig. Accordingly, at least charging/discharging of an activation process may be performed. When pressing the battery cell 100, the activation unit 530 may perform pressurization in a high temperature state.

The activation unit 530 may charge/discharge the battery cell 100 in a state in which the battery cell 100 is pressed at a high temperature by the pressing jig. As the battery cell 100 is pressed by the pressing jig during charging/discharging, a gas generated from the battery cell 100 may be gathered in the degassing portion 160. The sealing portion 150 of the battery cell 100 may be formed such that the generated gas may be gathered in the degassing portion 160, but the embodiment is not particularly limited.

The inside of the vacuum chamber 503 may be in a vacuum state (e.g., −40 kpa), and the gas collected in the pierced battery cell 100 is discharged (degassed) to the outside of the battery cell 100 due to a pressure difference. As the pressing jig presses the battery cell 100, the gas inside the battery cell 100 may be more easily discharged (degassed) to the outside.

The gas collected inside the battery cell 100 may be easily discharged to the outside due to the pressure difference and the pressure of the pressing jig.

In operation 450, the activation apparatus may perform sealing of a battery cell by using a movement member.

The battery cell 100, which has been activated and degassed in the activation unit 530, may be gripped and lifted by the movement member 200.

When the movement member 200 picks up (or grips) the battery cell 100, a heating pad 212 of the first movement member 210 and the vacuum pad 221 of the second movement member 220 may be coupled while facing each other. The heating pad 212 and the vacuum pad 211 may perform sealing of the degassing portion 160 of the battery cell 100 while coming into contact with and gripping or fixing the battery cell 100.

In operation 460, the activation apparatus may move the battery cell to the second chamber by using the movement member.

The movement member 200 may grip the sealed battery cell 100 and move the battery cell 100 into the second chamber 502 along the movement line 520.

The movement member 200 may move the battery cell 100 into the second chamber 502 via a second gate 542 between the vacuum chamber 503 and the second chamber 502.

The battery cell 100 may be placed on a second activation tray 541 inside the second chamber 502 by the movement member 200. A plurality of battery cells 100, which have been activated, may be disposed on the second activation tray 541. The activation apparatus 500 may perform sealing of the degassing portion 160 of the battery cell 100 even on the second activation tray 541 by using the heating pad 212 of the first movement member 210 and the vacuum pad 221 of the second movement member 220. The activation apparatus 500 may perform sealing of the degassing portion 160 of the battery cell 100 by using the heating pad 212 and the vacuum pad 221, even while the battery cell is being placed on the second activation tray 541 of the second chamber 502.

The second chamber 502 may adjust a vacuum level inside the second chamber 502. The vacuum level inside the second chamber 502 may be adjusted from an atmospheric state to a vacuum state (e.g., −40 kpa). When the movement member 200 moves into the second chamber 502 via the second gate 542, the vacuum level inside the second chamber 502 may be adjusted to a vacuum state (e.g., −40 kpa). Also, when the vacuum level of the second chamber 502 becomes a vacuum state (e.g., −40 kpa), the second gate 542 may be opened.

The battery cell 100 disposed on the second activation tray 541 may be conveyed to the outside of the activation apparatus 500 by a second conveyance unit 540 of the second chamber 502. In this case, the vacuum level inside the second chamber 502 may be adjusted to an atmospheric state. After the vacuum level is adjusted to the atmospheric state, the battery cell 100 may be conveyed to the outside of the activation apparatus 500 by the second conveyance unit 540.

The vacuum level inside the second chamber 502 may be adjusted before, while, and after the battery cell 100 is conveyed.

Although the present invention is described by specific embodiments and drawings, the present invention is not limited thereto, and various changes and modifications may be made by a person skilled in the art to which the present invention pertains within the technical idea of the present invention and equivalent scope of the appended claims.

### DESCRIPTION OF THE SYMBOLS

100: Battery cell
110: Electrode assembly
120: Pouch
130: Electrode lead
140: Electrode lead
150: Sealing portion
160: Degassing portion
200: Movement member
210: First movement member
211: Piercing pin
212: Heating pad
220: Second movement member
221: Vacuum pad
230: Rotary member
310: Piercing hole
320: Sealing region
500: Activation apparatus
501: First chamber
502: Second chamber
503: Vacuum chamber
510: First conveyance unit
511: First activation tray
512: First gate
520: Conveyance line
530: Activation unit
540: Second conveyance unit
541: Second activation tray
542: Second gate

1. An activation apparatus for a secondary battery, the activation apparatus comprising:
a first chamber having a first conveyor configured to convey a battery cell, the first chamber being configured to adjust a vacuum level in a space in which the first conveyor is located;
a vacuum chamber spatially connected to the first chamber, the vacuum chamber having an activation unit configured to receive the battery cell so that activation and degassing of the battery cell are performed, the vacuum chamber being configured to maintain a vacuum state in a space in which the activation unit is located;
a second chamber spatially connected to the vacuum chamber, the second chamber having a second conveyor configured to convey the battery cell, the second chamber being configured to adjust a vacuum level in a space in which the second conveyor is located;
a movement line crossing the first chamber, the vacuum chamber, and the second chamber; and
a carrier connected to the movement line, the carrier being configured to move the battery cell along the movement line,
wherein piercing of the battery cell is performed in the first chamber,
wherein the activation and degassing of the battery cell are performed in the activation unit, and
wherein sealing of the battery cell is performed in the vacuum chamber or the second chamber.

2. The activation apparatus of claim 1, wherein the carrier includes a first member and a second member,
wherein the first member has a heating pad on a first surface and a piercing pin on a second surface opposite the first surface,
wherein the second member has a vacuum pad on a first surface,
wherein the first member is rotatable between a state in which the piercing pin faces the vacuum pad and a state in which the heating pad faces the vacuum pad.

3. The activation apparatus of claim 2, wherein the piercing is performed by the piercing pin of the first member and the vacuum pad of the second member, and
wherein the sealing is performed by the heating pad of the first member and the vacuum pad of the second member.

4. The activation apparatus of claim 1, wherein the activation unit includes a pressing jig, and
wherein the pressing jig is configured to press the battery cell during the activation, thereby performing the degassing.

5. The activation apparatus of claim 1, wherein the first chamber has a first gate, and
wherein the first gate is configured to be opened when the vacuum level of the first chamber is adjusted to the vacuum state of the vacuum chamber.

6. The activation apparatus of claim 1, wherein the second chamber has a second gate, and
wherein the second gate is configured to be opened when the vacuum level of the second chamber is adjusted to the vacuum state of the vacuum chamber.

7. The activation apparatus of claim 1, wherein, in the sealing of the battery cell by the carrier:
a first sealing is performed while the carrier is brought into contact with the battery cell to move the battery cell, and
a second sealing is performed while the carrier places the battery cell in the second chamber.

8. The activation apparatus of claim 1, wherein the first chamber includes a first activation tray, and the battery cell conveyed from the first conveyor is disposed on the first activation tray, and
wherein the second chamber includes a second activation tray, and the battery cell moved from the vacuum chamber is disposed on the second activation tray.

9. The activation apparatus of claim 1, wherein the battery cell comprises a sealing portion and a degassing portion in the sealing portion, and
wherein a gas inside the battery cell is discharged via the degassing portion by pressing at least a portion of the sealing portion.

10. The activation apparatus of claim 1, wherein the activation of the battery cell is performed in the activation unit in a state in which the piercing has been performed.

11. An activation method for a secondary battery, comprising:
conveying a battery cell to a first chamber by a first conveyor;
adjusting a vacuum level in a space in which the first conveyor is located in the first chamber;
piercing the battery cell in the first chamber by carrier;
moving the battery cell to a vacuum chamber along a movement line by the carrier, wherein the vacuum chamber is in a vacuum state;
activating and degassing the battery cell by an activation unit located in the vacuum chamber;
sealing the battery cell by the carrier;
moving the battery cell to a second chamber along the movement line by carrier; and
adjusting a vacuum level in the second chamber.

12. The activation method of claim 11, further comprising pressing the battery cell during the activating the battery cell, thereby degassing the battery cell.

13. The activation method of claim 11, further comprising opening a first gate of the first chamber when the vacuum level of the first chamber is adjusted to the vacuum state of the vacuum chamber.

14. The activation method of claim 13, further comprising opening a second gate of the second chamber when the vacuum level of the second chamber is adjusted to the vacuum state of the vacuum chamber.

15. The activation method of claim 11, wherein the activating of the battery cell in the activation unit occurs after the piercing of the battery cell.
